(19) United States
(12) Patent Application Publication
(10) Pub. No.: US 2014/0170259 A1
(43) Pub. Date: Jun. 19, 2014

(54) NUTRITIONAL COMPOSITION FOR PROMOTING SATIETY

(71) Applicant: MEAD JOHNSON NUTRITION COMPANY, Glenview, IL (US)

(72) Inventors: Eduard K. Poels, Newburgh, IN (US); Colin Rudolph, San Francisco, CA (US); Peter van Dael, Newburgh, IN (US); Anja Wittke, Evansville, IN (US); Robert J. McMahon, Cincinnati, OH (US)

(73) Assignee: MEAD JOHNSON NUTRITION COMPANY, Glenview, IL (US)

(21) Appl. No.: 13/715,459

(22) Filed: Dec. 14, 2012

(51) Int. Cl. A23L 1/29

(52) U.S. Cl. CPC A23L 1/296
USPC 426/2; 426/656

(57) ABSTRACT

Provided herein are nutritional compositions comprising a protein source, a fat source, a carbohydrate source, and at least one nucleotide, wherein the protein source comprises at least one free amino acid, wherein the at least one free amino acid comprises a glutamate salt, glutamic acid, taurine, glutamine, alanine, or any combination thereof. Also provided herein are methods of promoting satiety, preventing or reducing the incidence of overweight or obesity, or preventing or reducing the incidence of diabetes in a subject comprising administering to a subject a nutritional composition comprising a protein source, a fat source, a carbohydrate source, and at least one nucleotide, wherein the protein source comprises at least one free amino acid, wherein the at least one free amino acid comprises a glutamate salt, glutamic acid, taurine, glutamine, alanine, or any combination thereof.

TECHNICAL FIELD

The present disclosure relates to a nutritional composition comprising at least one free amino acid, such as a glutamic acid, taurine, glutamine, alanine and combinations thereof. The nutritional compositions disclosed herein are, in particular embodiments, capable of promoting satiety in a subject.

### BACKGROUND

Early nutrition may have life-long consequences on body weight and overall health. Because dietary protein significantly affects the endocrine and metabolic response in infants (Socha, P., et al., Am. J. Clin. Nutr. 2011, 94(6 Suppl): 1776S-1784S), an adequate amount of protein is needed for protein synthesis and ultimately growth. In the first months of life, human breast milk or commercially available infant formula provide the sole source of nutrition for infants. However, formula fed infants tend to have a higher caloric intake than breast fed infants, which leads to higher body weight and certain health consequences later in life. (Kuczmarski, R. J. et al. CDC Growth charts, United States Adv. Data 2000; (314):1-27, 2000; WHO growth curves 2006, www.who.int/childgrowth/en). More particularly, rapid weight gain during the first year of life has been associated with an increased risk of obesity and diabetes later in life (Harder, Bergmann et al. 2005; Robinson et al. 2009; Druet et al. 2012). Meanwhile, a longer breast feeding duration was associated with a lower body fat mass by 4 years of age (Robinson, S. M. et al. J. Clin. Endocrinol. Metab. 2009, 94(8): 2799-2805). A lower bodyweight gain during the neonatal period leads to a decreases risk of obesity in adolescence and adulthood. Nevertheless, the influence of early feeding modes (i.e., breast versus formula) on obesity is still subject to some controversy (Michels et al., 2007, Int. J. Obes. 31(7): 1078-1085; Beyerlein et al. 2011 Am. J. Clin. Nutr. 94(6 Suppl): 1772S⁻1775S).

It has further been reported that the total volume intake is higher in formula fed infants than those nursed with breast milk (Bartok, C. J. 2011, Breastfeed Med. 6(3)117-124). While the feeding technique of breast v. bottle may play a role in volume intake, it is also possible that the compositional differences between infant formula and human milk that contribute to this difference.

Given the concerns about appropriate growth patterns in early childhood, there is a need for infant formulas that induce a sense of satiety and consequently reduce volume and calorie intake. Such formulas could thus promote a healthier body weight gain in pediatric subjects. Addressing the earliest stages of programming for healthy food intake and growth would be beneficial to pediatric subjects, and potentially provide long term health benefits, such as reducing the incidence of overweight, obesity and diabetes, and all of the health complications resulting therefrom.

### BRIEF SUMMARY

Briefly, the present disclosure is directed to, in certain embodiments, a nutritional composition comprising a protein source, a fat source, a carbohydrate source, and at least one nucleotide, wherein the protein source comprises at least one free amino acid, and wherein the at least one free amino acid comprises glutamic acid, taurine, glutamine, alanine, or any combination thereof. Exemplary nucleotides include 5′-ribonucelotides, such as inosine monophosphate, guanosine monophosphate, or a combination thereof.

In certain embodiments, the nutritional composition provided herein is capable of promoting or inducing satiety when ingested by a subject. Accordingly, the present disclosure also provides a method of promoting or inducing satiety in a subject, comprising administering to the subject a nutritional composition comprising at least one free amino acid, wherein the at least one free amino acid comprises glutamic acid, taurine, glutamine, alanine, or any combination thereof. Suitable subjects include, without limitation, pediatric subjects, such as infants or children.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth herein below. Each example is provided by way of explanation of the nutritional composition of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

“Nutritional composition” means a substance or formulation that satisfies at least a portion of a subject's nutrient requirements. The terms “nutritional(s)”, “nutritional formula(s)”, “enteral nutritional(s)”, “nutritional composition(s)”, and “nutritional supplement(s)” are used interchangeably throughout the present disclosure to refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults, such as women who are lactating or pregnant.

The term “enteral” means through or within the gastrointestinal, or digestive, tract. “Enteral administration” includes oral feeding, intragastric feeding, transpyloric administration, or any other administration into the digestive tract.

“Pediatric subject” means a human that is less than 13 years of age. In some embodiments, a pediatric subject refers to a human subject that is less than 8 years old. In other embodiments, a pediatric subject refers to a human subject between 1 and 6 years of age. In still further embodiments, a pediatric subject refers to a human subject between 6 and 12 years of age. Thus, pediatric subjects include infants and children.

“Infant” means a subject having an age of not more than about one year and includes infants from 0 to about 12 months. The term infant includes low birth weight infants, very low birth weight infants, and preterm infants. “Preterm” means an infant born before the end of the 37th week of gestation, while “full term” means an infant born after the end of the 37th week of gestation.

“Child” means a subject ranging in age from about 12 months to about 13 years. In some embodiments, a child is a subject between the ages of 1 and 12 years old. In other embodiments, the terms “children” or “child” refer to subjects that are between about one and about six years old, or between about seven and about 12 years old. In other embodiments, the terms “children” or “child” refer to any range of ages between about 12 months and about 13 years.

“Children's nutritional product” refers to a composition that satisfies at least a portion of the nutrient requirements of a child. A growing-up milk is an example of a children's nutritional product.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Milk-based” means comprising at least one component that has been drawn or extracted from the mammary gland of a mammal. In some embodiments, a milk-based nutritional composition comprises components of milk that are derived from domesticated ungulates, ruminants or other mammals or any combination thereof. Moreover, in some embodiments, milk-based means comprising bovine casein, whey, lactose, or any combination thereof. Further, “milk-based nutritional composition” may refer to any composition comprising any milk-derived or milk-based product known in the art.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant.

A nutritional composition that is “nutritionally complete” for a term infant will, by definition, provide qualitatively and quantitatively adequate amounts of all carbohydrates, lipids, essential fatty acids, proteins, essential amino acids, conditionally essential amino acids, vitamins, minerals, and energy required for growth of the term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

“Nutritional supplement” or “supplement” refers to a formulation that contains a nutritionally relevant amount of at least one nutrient. For example, supplements described herein may provide at least one nutrient for a human subject, such as a lactating or pregnant female.

“Probiotic” means a microorganism with low or no pathogenicity that exerts a beneficial effect on the health of the host.

“Prebiotic” means a non-digestible food ingredient that beneficially affects the host by selectively stimulating the growth and/or activity of one or a limited number of beneficial gut bacteria in the digestive tract, selective reduction in gut pathogens, or favorable influence on gut short chain fatty acid profile that can improve the health of the host.

“β-glucan” means all β-glucan, including both β-1,3-glucan and β-1,3;1,6-glucan, as each is a specific type of β-glucan. Moreover, β-1,3;1,6-glucan is a type of β-1,3-glucan. Therefore, the term “β-1,3-glucan” includes β-1,3;1,6-glucan.

All percentages, parts and ratios as used herein are by weight of the total formulation, unless otherwise specified.

The nutritional composition of the present disclosure may be free of substantially free of any optional or selected ingredients described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified in any range. Any reference to a range should be considered as providing support for any subset within that range.

The present disclosure provides nutritional compositions comprising at least one free amino acid. The compositions provided herein, in certain embodiments, promote or induce satiety upon ingestion of the composition by a subject. As such, the compositions may be useful for promoting a healthful weight gain, preventing or reducing the incidence of overweight, obesity, and/or diabetes. For example, when the subject is an infant, the present compositions may be useful in promoting healthful weight gain and establishing lifelong eating habits that reduce the infant's risk of overweight, obesity and diabetes later in life. In certain embodiments, the nutritional composition comprises a protein source, a fat source, a carbohydrate source, and at least one nucleotide, wherein the protein source comprises at least one free amino acid, wherein the at least one free amino acid is glutamic acid, taurine, glutamine, alanine, or any combination thereof. In more particular embodiments, the composition comprises the glutamic acid, taurine, glutamine and alanine.

The nutritional compositions may comprise, in certain embodiments, a free amino profile such that the composition promotes satiety. For example, in some embodiments, the composition comprises at least about 5 mg of the free amino acid per 100 kcal of the composition. More specifically, the composition comprises about 5 to about 300 mg per 100 kcal, or about 10 to about 200 mg per 100 kcal of the free amino acid in some embodiments. In other embodiments, the composition comprises about 10 to about 150 mg of the free amino acid per 100 kcal, and more particularly, about 15 to about 80 mg of the free amino acid per 100 kcal.

The amounts of particular amino acids can be adjusted to any desired level. For example, the amount of glutamic acid, in certain embodiments, is about 2 mg per 100 kcal to about 180 mg per 100 kcal. In other embodiments, the composition comprises about 5 to about 120 mg per 100 kcal, about 10 to about 50 mg per 100 kcal, or about 20 to about 30 mg per 100 kcal of glutamic acid. While not being bound any particular theory, glutamate sensors in the gastrointestinal tract are known to activate several brain regions. This gut-brain communication may lead to a modified food intake following ingestion of a nutritional composition comprising glutamic acid or one of its salts. The glutamic acid may be provided as the free acid, a glutamate salt, or a combination thereof. In certain embodiments, the nutritional composition is a powdered composition, and the glutamic acid and other free amino acids are provided as the free acid. In other embodiments, useful salts include the mono-anion of glutamic acid and a suitable cation such as those derived from ammonium (ammonium glutamate mol. wt.=164.16 g per mol), sodium (monosodium glutamate mol. wt.=169.11 g per mol), potassium (monopotassium glutamate mol. wt.=185.22 g per mol), magnesium (magnesium diglutamate, mol. wt.=316.55 g per mol), calcium (calcium diglutamate, mol. wt.=332.32 g per mol) as a convenient equivalent source of the amino acid. Glutamic acid levels can be calculated from the molecular weights of such salts relating these to that of the fully protonated acid (glutamic acid, mol. wt.=147.13 g per mol). When a glutamate salt is used, it preferably is not a sodium salt.

In other embodiments, the composition comprises about 1 to about 25 mg per 100 kcal, about 2 to about 15 mg per 100 kcal, or about 3 to about 13 mg per 100 kcal of the glutamine. In certain embodiments, the composition comprises about 1 to about 25 mg per 100 kcal, about 2 to about 15 mg per 100 kcal, or about 5 to about 10 mg per 100 kcal of the taurine. In other particular embodiments, the composition comprises about 0.25 to about 20 mg per 100 kcal, about 0.5 to about 10 mg per 100 kcal or about 1 to about 5 mg per 100 kcal of the alanine.

The effect that protein intake has on growth of a subject also depends on the subject's digestive capacity. For example, in the first weeks of life, the digestive capacity of infants has not reached its full capacity. Amino acids may be more readily absorbed in the immature digestive system, thereby promoting satiety, and consequently a healthier body weight and rate of body weight gain in these early weeks. Furthermore, feeding free amino acids could increase the rate of absorption into serum for, and therefore reduce total formula intake while providing beneficial effects on body composition and long-term health. Finally, infants may learn healthy caloric intake early in life, and therefore provide lifelong healthy eating habits.

The nutritional compositions provided herein may optionally further comprise at least one nucleotide, and more particularly, at least one ribonucleotide, such as a 5′-ribonucleotide. Without being bound by any particular theory, it is believed that the inclusion of a 5′-ribonucleotide may enhance the satiety-promoting effects of the present compositions. For example, 5′-ribonucleotides have been shown to be allosteric agonists for the GPCR T1R1+T1R3 umami receptor (Xu, H. et al., PNAS, 2004, 101:14258-14263). If the umami receptor signaling is the reason its observed effects on satiety, then 5′-ribonucleotides may enhance this effect. The 5′-ribonucleotide can be, in particular embodiments, an inosine monophosphate, guanosine monophosphate, or a combination thereof. More particularly, the 5′-ribonucleotide can be a combination of inosine monophosphate, guanosine monophosphate in a ratio of between 10:1 to 1:10, more typically in a ratio close to 1:1. Ribotide® (CAS No. 80702-47-2), sold by Sucrogen Bioethanol, is a commercially available food ingredient comprising inosine monophosphate and guanosine monophosphate (specifically disodium inosate and disodium guanylate), and is useful a source of 5′-ribonucelotides in the present composition. The pure compounds can also for instance be obtained from Yamasa Corporation, Biochemicals Division. Disodium 5′-ribonucleotides flavor enhancer is also characterized by E number E635, a combination of disodium guanylate (E626) and inosinate (E630). These products can optionally be derived from yeast autolysate, fish or meat.

The Life Sciences Research Office (LSRO), American Societies for Nutritional Sciences Assessment of Nutrient Requirements for Infant Formulas (J Nutr 1998; 128(Supp):20595-22985) recommends that the level of free nucleotides, including available nucleosides, nucleic acids (DNA and RNA) that serve as nucleotide precursors in infant formula be limited to a maximum of 16 mg per 100 kcal, a value similar to their upper limit in human milk. The European Commission Directive 2006/141/EC of 22 Dec. 2006 on infant formulae and follow-on formulae and amending Directive 1999/21/EC, stipulates that the 5′-monophophates of cytidine, uridine, adenosine, guanosine and inosine may be added and that the total concentration of the nucleotides shall not exceed 5 mg per 100 kcal. Accordingly, in some embodiments, the amount of the 5′-ribonucleotide ranges from about 0.05 to about 16 mg per 100 kcal, about 0.1 to about 5 mg per 100 kcal, or about 0.2 to about 1.5 mg per 100 kcal. Another way to derive an optimal ribonucleotide level is as a weight percentage of the glutamic acid levels, for example about 0.1-10% of the glutamic acid, or about 1-5% of the glutamic acid.

In a particular embodiment, the nutritional composition comprises a protein source, a fat source, a carbohydrate source, and at least one nucleotide, wherein the protein source comprises a whole protein source and a mixture of free amino acids comprising glutamic acid, taurine, glutamine, and alanine. The amounts of the free amino acids may be, in some embodiments, the amounts described herein. For example, the nutritional composition may include about 2 to 180 mg per 100kcal of glutamic acid, about 1 to about 25 mg per 100kcal glutamine, about 1 to about 25 mg per 100 kcal of taurine, and about 0.25 to about 20 mg per 100 kcal of alanine. The aforesaid composition may further comprise, in certain embodiments, at least one 5′ nucleotide, such as inosine monophosphate, guanosine monophosphate, or a mixture thereof.

The compositions described herein are, in particular embodiments, capable of promoting satiety in a subject. Without being bound by any particular theory, it is believed that upon enteral administration to a subject, particularly an infant, will learn to self-regulate food intake earlier in life and thus avoid becoming overweight or obese, and accordingly, avoid the health consequences associated with these conditions, such as diabetes. These advantageous effects on regulating food intake may last throughout a subject's life. Furthermore, in certain embodiments, it is believed that the present compositions are capable of promoting a growth profile similar to that of breast fed infants.

Accordingly, the present disclosure also provides methods of promoting satiety in a subject comprising enteral administration of a composition as described herein to a subject. The composition may be nutritionally complete, such that it can be the sole source of nutrition for the subject. For example, in certain embodiments, the composition is a children's nutritional product, such as an infant formula or a growing-up milk. The present disclosure further provides methods for reducing the incidence of overweight, obesity and/or diabetes in a subject comprising administering to a subject a nutritional composition described herein. The subject may be an infant, a child, or even an adult subject, but in particular embodiments, the subject is an infant. For example, administering an infant formula of the present disclosure to an infant will, in certain embodiments, reduce the incidence of obesity and/or diabetes later in life.

The disclosed nutritional composition(s) may be provided in any form known in the art, such as a powder, a gel, a suspension, a paste, a solid, a liquid, a liquid concentrate, a reconstituteable powdered milk substitute or a ready-to-use product. The nutritional composition may, in certain embodiments, comprise a nutritional supplement, children's nutritional product, infant formula, human milk fortifier, growing-up milk or any other nutritional composition designed for a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, more preferably in the range of 10 μm to 1000 μm, and even more preferably in the range of 50 μm to 300 μm.

In some embodiments, the disclosure provides a fortified milk-based growing-up milk designed for children ages 1-3 years and/or 4-6 years, wherein the growing-up milk supports growth and development and life-long health. In some embodiments, the disclosure provides an infant formula suitable for infants ranging in age from 0 to 12 months, or from 0 to 3 months, 0 to 6 months or 6 to 12 months.

The protein source of the present nutritional compositions may comprise, in addition to the at least one amino acid, other protein sources commonly used in the art, e.g., nonfat milk, whey protein, casein, soy protein, whole protein, hydrolyzed protein, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof. In yet another embodiment, the protein source may be supplemented with glutamine-containing peptides.

The protein source comprises, in certain embodiments, at least one a whole protein source, in addition to the at least one amino acid. More particularly, in certain embodiments, the protein source does not comprise hydrolyzed proteins or partially hydrolyzed proteins. Exemplary whole protein sources include casein, whey protein (including whey protein isolate or whey protein concentrate), or soy protein. In a particular embodiment, the whole protein source comprises casein protein, whey protein, or a combination thereof, while in other embodiments, the whole protein source comprises soy protein.

The amount of protein in the nutritional composition comprises, in certain embodiments, between about 1 g and about 5 g of protein per 100kcal. In other embodiments, the amount of protein comprises between about 1.4 and about 3.5 g per 100kcal.

Suitable fat or lipid sources for the nutritional composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

Carbohydrate sources can be any used in the art, e.g., lactose, glucose, fructose, corn syrup solids, maltodextrins, sucrose, starch, rice syrup solids, and the like. The amount of carbohydrate in the nutritional composition typically can vary from between about 5 g and about 25 g/100 kcal.

In one embodiment, the nutritional composition may contain one or more probiotics. Any probiotic known in the art may be acceptable in this embodiment. In a particular embodiment, the probiotic may be selected from any Lactobacillus species, Lactobacillus rhamnosus GG (e.g., ATCC number 53103), Bifidobacterium species, Bifidobacterium longum (e.g. AH1205 or AH1206), and Bifidobacterium animalis subsp. lactis BB-12 (DSM No. 10140), Bifidobacterium infantis (e.g. 35624), or any combination thereof.

If included in the composition, the amount of the probiotic may vary from about 1×10⁴ to about 1×10¹² colony forming units (cfu) per gram of the nutritional composition. In another embodiment, the amount of the probiotic may vary from about 1×10⁶ to about 1×10¹² cfu per gram of the nutritional composition. In still another embodiment, the amount of the probiotic may vary from about 1×10⁶ to about 1×10⁹ cfu per gram of the nutritional composition, or about 1×10⁹ to about 1×10¹² cfu per gram of the nutritional composition. In yet another embodiment, the amount of the probiotic may be at least about 1×10⁶ cfu per gram of the nutritional composition.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such new source is now known or later developed.

The nutritional composition may also contain one or more prebiotics in certain embodiments. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides.

In an embodiment, the total amount of prebiotics present in the nutritional composition may be from about 1.0 g/L to about 10.0 g/L of the composition. For example, in some embodiments, polydextrose (PDX) may be included in the nutritional composition in an about of about 1.0 to 10.0 g/L. In another embodiment, the amount of PDX is about 2.0 to about 8.0 g/L.

In certain embodiments, at least 20% of the prebiotics can comprise galacto-oligosaccharide (GOS), (PDX) or a mixture thereof. In an embodiment, the PDX and GOS have a PDX:GOS ratio of between about 9:1 and 1:9. In another embodiment, the ratio of PDX:GOS can be about 5:1 to 1:5. In yet another embodiment, the ratio of PDX:GOS can be between about 1:3 and 1:3. In further more particular embodiments, the ratio can be about 1:1 or 4:1. In another embodiment, the amount of the PDX:GOS combination may be between about 2.0 g/L and 8.0 g/L. In a particular embodiment, the amount of the PDX:GOS combination may be about 2 g/L of PDX and 2 g/L of GOS. At least 20% of the prebiotics can comprise galacto-oligosaccharide (“GOS”), polydextrose or a mixture thereof. The amount of each of GOS and/or polydextrose in the nutritional composition may, in an embodiment, be within the range of from about 1.0 g/L to about 4.0 g/L.

The nutritional composition of the disclosure may contain a source of long chain polyunsaturated fatty acid (LCPUFA) that comprises docosahexaenoic acid. Other suitable LCPUFAs include, but are not limited to, α-linoleic acid, γ-linoleic acid, linoleic acid, linolenic acid, docosahexaenoic acid (DHA), eicosapentaenoic acid (EPA) and arachidonic acid (ARA).

In an embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

If included, the source of DHA and/or ARA may be any source known in the art such as marine oil, fish oil, single cell oil, egg yolk lipid, and brain lipid. In some embodiments, the DHA and ARA are sourced from single cell Martek oils, DHASCO® and ARASCO®, or variations thereof. The DHA and ARA can be in natural form, provided that the remainder of the LCPUFA source does not result in any substantial deleterious effect on the subject. Alternatively, the DHA and ARA can be used in refined form.

In an embodiment, sources of DHA and ARA are single cell oils as taught in U.S. Pat. Nos. 5,374,657; 5,550,156; and 5,397,591, the disclosures of which are incorporated herein in their entirety by reference. Nevertheless, the present disclosure is not limited to only such oils.

The nutritional composition may also comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-_{g}lucans are carbohydrate polymers purified from, for example, yeast, mushroom, bacteria, algae, or cereals. (Stone B A, Clarke A E. Chemistry and Biology of (1-3)-Beta-Glucans. London:Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000;120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalities, including a backbone of straight chain glucose units linked by a β-1,3 bond with β-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

In an embodiment, the nutritional composition(s) of the present disclosure comprises choline. Choline is a nutrient that is essential for normal function of cells. It is a precursor for membrane phospholipids, and it accelerates the synthesis and release of acetylcholine, a neurotransmitter involved in memory storage. Moreover, though not wishing to be bound by this or any other theory, it is believed that dietary choline and docosahexaenoic acid (DHA) act synergistically to promote the biosynthesis of phosphatidylcholine and thus help promote synaptogenesis in human subjects. Additionally, choline and DHA may exhibit the synergistic effect of promoting dendritic spine formation, which is important in the maintenance of established synaptic connections. In some embodiments, the nutritional composition(s) of the present disclosure includes about 40 mg choline per serving to about 100 mg per 8 oz. serving.

In an embodiment, the nutritional composition comprises a source of iron. In an embodiment, the source of iron is ferric pyrophosphate, ferric orthophosphate, ferrous fumarate or a mixture thereof and the source of iron may be encapsulated in some embodiments.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the subject. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In certain embodiments, the composition may optionally include, but is not limited to, one or more of the following vitamins or derivations thereof: vitamin B1 (thiamin, thiamin pyrophosphate, TPP, thiamin triphosphate, TTP, thiamin hydrochloride, thiamin mononitrate), vitamin B2 (riboflavin, flavin mononucleotide, FMN, flavin adenine dinucleotide, FAD, lactoflavin, ovoflavin), vitamin B3 (niacin, nicotinic acid, nicotinamide, niacinamide, nicotinamide adenine dinucleotide, NAD, nicotinic acid mononucleotide, NicMN, pyridine-3-carboxylic acid), vitamin B3′-precursor tryptophan, vitamin B6 (pyridoxine, pyridoxal, pyridoxamine, pyridoxine hydrochloride), pantothenic acid (pantothenate, panthenol), folate (folic acid, folacin, pteroylglutamic acid), vitamin B12 (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K2, menaquinone-7, vitamin K3, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In other embodiments, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to growing-up milks or to other children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

The children's nutritional composition of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 2 to about 7 g/100 kcal. The amount of protein typically can vary from about 1 to about 5 g/100 kcal. The amount of carbohydrate typically can vary from about 8 to about 14 g/100 kcal.

In some embodiments, the nutritional composition of the present disclosure is a growing-up milk. Growing-up milks are fortified milk-based beverages intended for children over 1 year of age (typically from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of an infant formula or a growing-up milk or other nutritional composition according to the present disclosure can vary from market-to-market, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition is typically derived from the milk raw materials. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The pediatric subject may be a child or an infant. For example, the subject may an infant ranging in age from 0 to 3 months, about 0 to 6 months, 0 to 12 months, 3 to 6 months, or 6 to 12 months. The subject may alternatively be a child ranging in age from 1 to 13 years, 1 to 6 years or 1 to 3 years. In an embodiment, the composition may be administered to the pediatric subject prenatally, during infancy, and during childhood.

Examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the example, be considered to be exemplary only, with the scope and spirit of the disclosure being indicated by the claims which follow the example.

### EXAMPLES

In this example, the effect of the 4 most abundant amino acids found in human milk (glutamic acid, glutamine, taurine, and alanine) is examined by adding them to an infant formula with either 2.1 g of protein per 100 Kcal or 1.8 g of protein per 100 Kcal. The levels of free amino acids added to the formulas are as follows: 3 mg of alanine, 23 g of glutamic acid, 7.6 g of taurine and 9 grams of glutamine, per 100 Kcal of formula. Primate neonates receive these formulations for 4 months, during which time formula intake and various parameters representative of their growth are collected. A control group of primate neonates receive the same formulations without the supplemental amino acids.

An infant formula base having 2.1 g/100kcal of protein used in this example is described in Table 1:

TABLE 1
Quantity per 100 g of infant formula base

| Ingredient | g/100 kg base |
|---|---|
| Lactose | 36.67100 |
| Fat blend | 25.60000 |
| Whey protein concentrate | 23.30000 |
| Milk non-fat dry | 7.60000 |
| Galacto-oligosaccharide syrup | 3.67800 |
| Lecithin | 0.79400 |
| Fungal-algal oil blend | 0.71600 |
| Calcium carbonate | 0.45000 |
| Choline chloride | 0.17000 |
| Potassium citrate | 0.12000 |
| Calcium phosphate tribasic | 0.11000 |
| Potassium chloride | 0.01800 |
| Magnesium oxide | 0.01300 |
| L-carnitine | 0.01100 |
| Sodium chloride | 0.00600 |
| Polydextrose powder | 1.85000 |

The infant formula base is used to prepare an infant formula powder comprising free amino acids, as described in Table 2.

TABLE 2
Exemplary infant formula powder with free amino acids

| Ingredient | g |
|---|---|
| Infant Formula Base | 98.83000 |
| Dry Vitamin Premix -No Taurine | 0.32100 |
| Nucleotide premix | 0.16600 |
| Iron trituration | 0.25300 |
| Trace/ultra trace mineral premix | 0.15000 |
| Free amino acid premix | 0.28000 |

The macronutrient and amino acid content of the control and free amino acid formulas used in this example are set forth in Table 3.

TABLE 3
Theoretical values of macronutrients and free amino
acid composition of test formulas per 100 kcal.

| | | | |
|---|---|---|---|
| | Newborn | | Newborn |
| Newborn | Control | Newborn | Control |
| Control | (2.1 g/ | Control | (1.8 g/ |
| (2.1 g/ | 100 Kcal) | (1.8 g/ | 100 Kcal) |
| 100 Kcal) | Plus FAA | 100 Kcal) | Plus FAA |

Macronutrients

| | g/100 Kcal | g/100 Kcal | g/100 Kcal | g/100 Kcal |
|---|---|---|---|---|
| Protein | 2.116 | 2.145 | 1.814 | 1.845 |
| CHO | 5.38 | 5.38 | 5.36 | 5.36 |
| Fat | 11.05 | 11.05 | 11.4 | 11.4 |

Added free amino acids

| | mg/100 Kcal | mg/100 Kcal | mg/100 Kcal | mg/100 Kcal |
|---|---|---|---|---|
| Ala | 0 | 3 | 0 | 3 |
| Glu | 0 | 23 | 0 | 23 |
| Taurine | 0 | 7.6 | 0 | 7.6 |
| Gln | 0 | 9 | 0 | 9 |

1. A nutritional composition comprising a protein source, a fat source, a carbohydrate source, and at least one nucleotide,
wherein the protein source comprises a mixture of a free amino acids comprising glutamic acid, taurine, glutamine, and alanine, and wherein the amount of the glutamic acid ranges from about 2 mg per 100 kcal to about 180 mg per 100 kcal.

2. The nutritional composition of claim 1, wherein the composition comprises at least about 5 mg/100kcal of the mixture of free amino acids.

3. (canceled)

4. The nutritional composition of claim 1, wherein the glutamic acid is provided as a glutamate salt, wherein the salt is a potassium salt, a calcium salt, a magnesium salt, a sodium salt, an ammonium salt or combinations thereof.

5. The nutritional composition of claim 4, wherein glutamate salt is not a sodium salt.

6. (canceled)

7. The composition of claim 1, wherein the amount of the glutamine is about 1 to about 25 mg per 100kcal of the composition, the amount of the taurine is about 1 to about 25 mg per 100 kcal of the composition, and the amount of the alanine is about 0.25 to about 20 mg per 100 kcal of the composition.

8. The composition of claim 1, wherein the at least one nucleotide comprises a 5′-ribonucleotide.

9. The nutritional composition of claim 8, wherein the at least one nucleotide comprises inosine monophosphate, guanosine monophosphate, or a mixture thereof.

10. The nutritional composition of claim 1, wherein the at least one nucleotide is present in an amount ranging from about 0.05 to about 16 mg per 100 kcal.

11. The nutritional composition of claim 1, wherein the amount of protein in the composition is about 1.4 to about 3.5 g per 100 kcal.

12. The nutritional composition of claim 1, wherein the protein source comprises the at least one free amino acid and a whole protein source.

13. The nutritional composition of claim 12, wherein the protein source does not include a hydrolyzed or partially hydrolyzed protein.

14. The nutritional composition of claim 1, which is capable of promoting satiety in a subject when consumed by a subject in need thereof.

15. The nutritional composition of claim 14, wherein the subject is an infant or a child.

16. The nutritional composition of claim 1, wherein the nutritional composition is a children's nutritional product.

17. The nutritional composition of claim 1, wherein the nutritional composition is an infant formula.

18. A method of promoting satiety in a subject, comprising administering to a subject in need thereof a nutritional composition comprising a protein source, a fat source, a carbohydrate source, and at least one nucleotide,
wherein the protein source comprises at least one free amino acid, wherein the free amino acid is glutamic acid, taurine, glutamine, alanine, or any combination thereof.

19. A method of preventing or reducing the incidence of obesity in a subject, comprising administering to a subject in need thereof a nutritional composition comprising a protein source, a fat source, a carbohydrate source, and at least one nucleotide, wherein the protein source comprises at least one free amino acid, wherein the free amino acid is glutamic acid, taurine, glutamine, alanine, or any combination thereof.

20. A method of preventing or reducing the incidence of diabetes in a subject, comprising administering to a subject in need thereof a nutritional composition comprising a protein source, a fat source, a carbohydrate source, and at least one nucleotide,
wherein the protein source comprises at least one free amino acid, wherein the free amino acid is glutamic acid, taurine, glutamine, alanine, or any combination thereof.
